(19) United States
(12) Patent Application Publication
(10) Pub. No.: US 2026/0122056 A1
(43) Pub. Date: Apr. 30, 2026

(54) PROTECTED SHARING OF PASSWORD-PROTECTED RESOURCES

(71) Applicant: ISLAND TECHNOLOGY INC., DALLAS, TX (US)

(72) Inventors: TAMIR TODER, TEL AVIV (IL); DAN AMIGA, RANAT HASHARON (IL); ALON BIRAN, RAMAT HASHARON (IL)

(21) Appl. No.: 19/369,567

(22) Filed: Oct. 27, 2025

Related U.S. Application Data
(60) Provisional application No. 63/712,471, filed on Oct. 27, 2024.

(51) Int. Cl. H04L 9/40

(52) U.S. Cl. CPC H04L 63/083

(57) ABSTRACT

A computer security method including detecting when a web browser accesses a login form of a website, accessing a credential record associated with the website, where the credential record includes a login and a password, inputting the login into a login field of the login form, inputting a password placeholder value into a password field of the login form, where the password placeholder value differs from the password included in the credential record, detecting an attempt by a user of the web browser to submit a login request to the website, where the login request includes the login and the password placeholder value from the login form, replacing the password placeholder value in the login request with the password included in the credential record, and submitting the login request to the website, where the submitted login request includes the login and the password included in the credential record.

### FIELD

The invention relates generally to computer security.

### BACKGROUND

One way that computer users share access to password-protected software applications is where an authorized user of an application makes their application user credentials, including their login and password, known to another user. This poses security risks, such as where the recipient changes the password or shares the credentials with other users without the knowledge or permission of the authorized user.

### SUMMARY

In one aspect of the invention a computer security method is provided including detecting when a web browser accesses a login form of a website, accessing a credential record associated with the website, where the credential record includes a login and a password, inputting the login into a login field of the login form, inputting a password placeholder value into a password field of the login form, where the password placeholder value differs from the password included in the credential record, detecting an attempt by a user of the web browser to submit a login request to the website, where the login request includes the login and the password placeholder value from the login form, replacing the password placeholder value in the login request with the password included in the credential record, and submitting the login request to the website, where the submitted login request includes the login and the password included in the credential record.

In another aspect of the invention the detecting, accessing, inputting, replacing, and submitting are performed by the web browser.

In another aspect of the invention the detecting, accessing, inputting, replacing, and submitting are performed by an extension of the web browser.

In another aspect of the invention the computer security method further includes retrieving the password placeholder value from the credential record.

In another aspect of the invention the login identifies a person other than the user of the web browser.

In another aspect of the invention the detecting, accessing, inputting, replacing, and submitting are implemented in any of a) computer hardware, and b) computer software embodied in a non-transitory, computer-readable medium.

In another aspect of the invention a computer security method is provided including receiving from a web browser a login request that is addressed to a website, where the login request includes a login and a password placeholder value, accessing a credential record associated with the login and the website, where the credential record includes the login and a password, replacing the password placeholder value in the login request with the password included in the credential record, and submitting the login request to the website, where the submitted login request includes the login and the password included in the credential record.

In another aspect of the invention the computer security method further includes providing the credential record to a user of the web browser, prior to receiving the login request, in accordance with an identification indicating that the credential record is to be shared with the user of the web browser, where the login identifies a person other than the user of the web browser.

In another aspect of the invention the receiving, accessing, replacing, and submitting are performed by a proxy server.

In another aspect of the invention the computer security method further includes proxying communications between the website and the web browser.

In another aspect of the invention the receiving, accessing, replacing, and submitting are implemented in any of a) computer hardware, and b) computer software embodied in a non-transitory, computer-readable medium.

### BRIEF DESCRIPTION OF THE DRAWINGS

Aspects of the invention will be understood and appreciated more fully from the following detailed description taken in conjunction with the appended drawings in which:

FIG. 1A is a simplified conceptual illustration of a computer security system, constructed and operative in accordance with an embodiment of the invention;

FIG. 1B is a simplified action diagram of an exemplary method of operation of the system of FIG. 1A, operative in accordance with an embodiment of the invention;

FIG. 1C is a simplified conceptual illustration of a computer security system, constructed and operative in accordance with an embodiment of the invention;

FIG. 1D is a simplified action diagram of an exemplary method of operation of the system of FIG. 1C, operative in accordance with an embodiment of the invention;

FIG. 1E is a simplified conceptual illustration of a computer security system, constructed and operative in accordance with an embodiment of the invention;

FIG. 1F is a simplified action diagram of an exemplary method of operation of the system of FIG. 1E, operative in accordance with an embodiment of the invention;

FIG. 1G is a simplified conceptual illustration of a computer security system, constructed and operative in accordance with an embodiment of the invention; and

FIG. 1H is a simplified action diagram of an exemplary method of operation of the system of FIG. 1G, operative in accordance with an embodiment of the invention.

### DETAILED DESCRIPTION

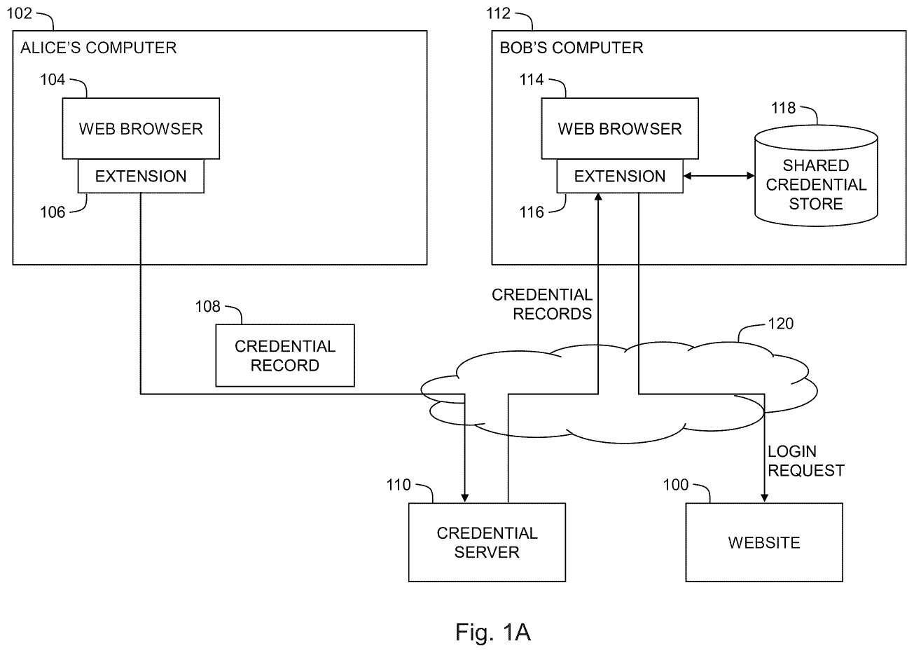

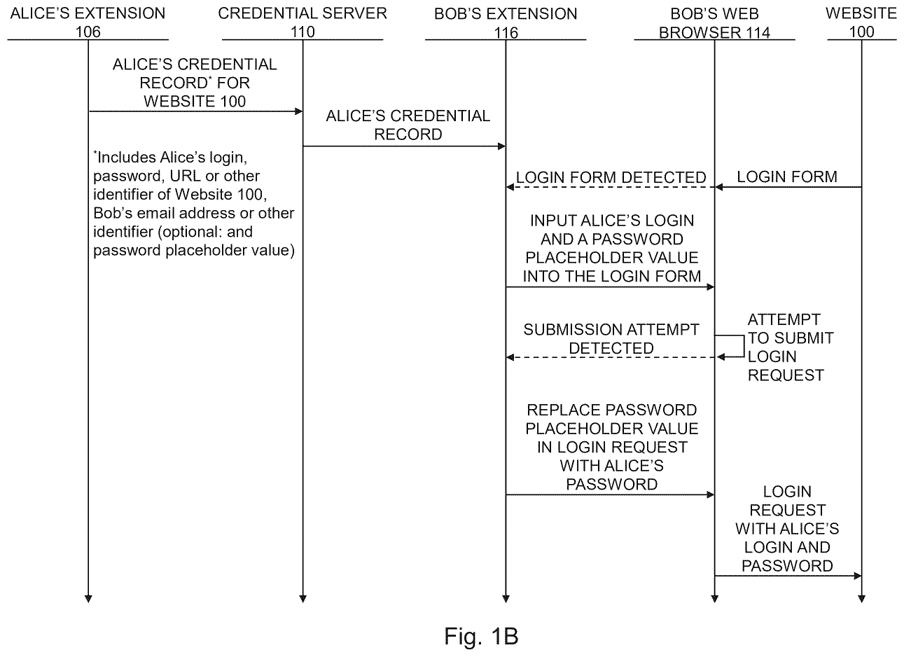

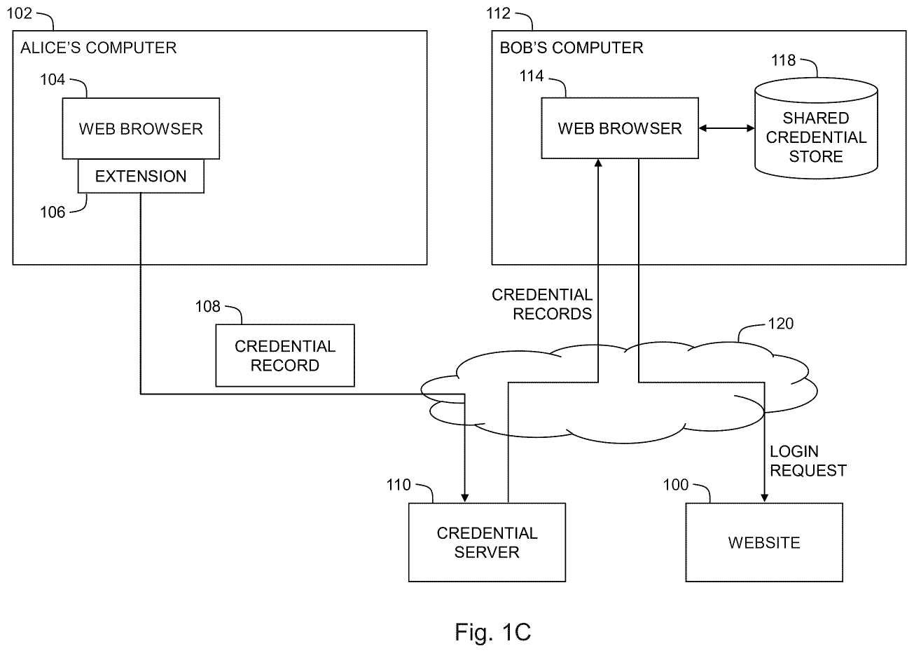

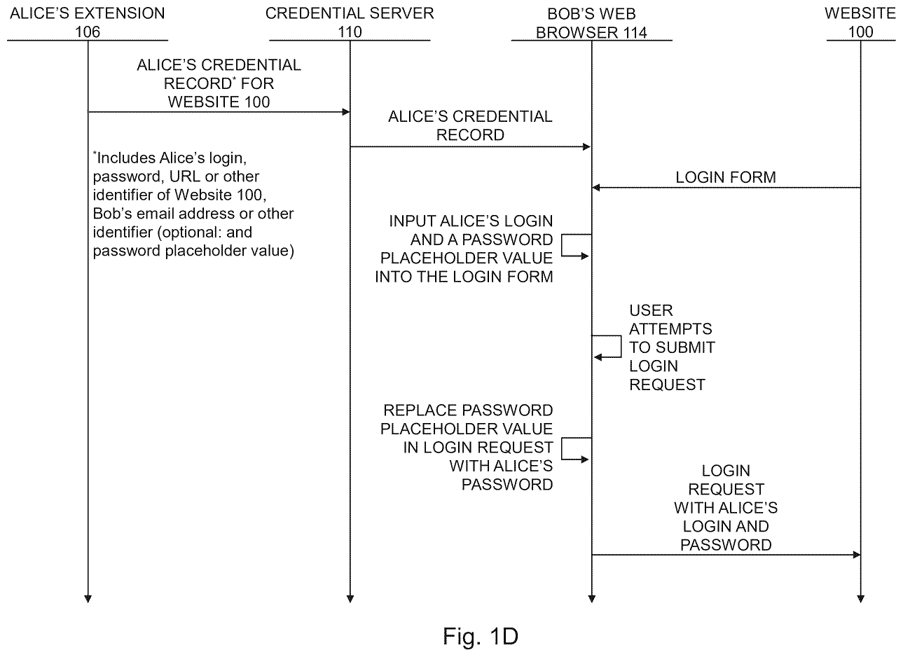

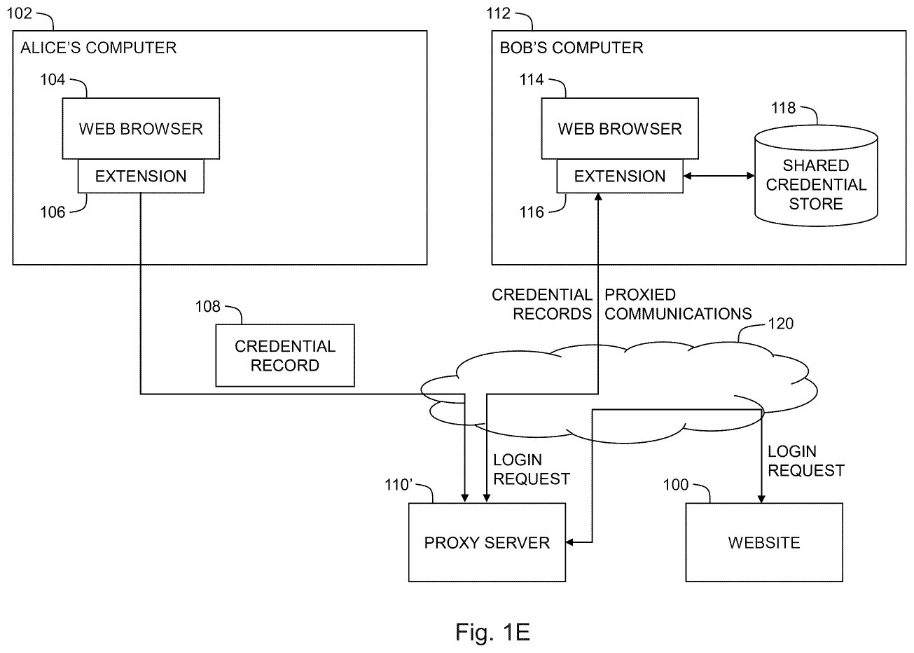

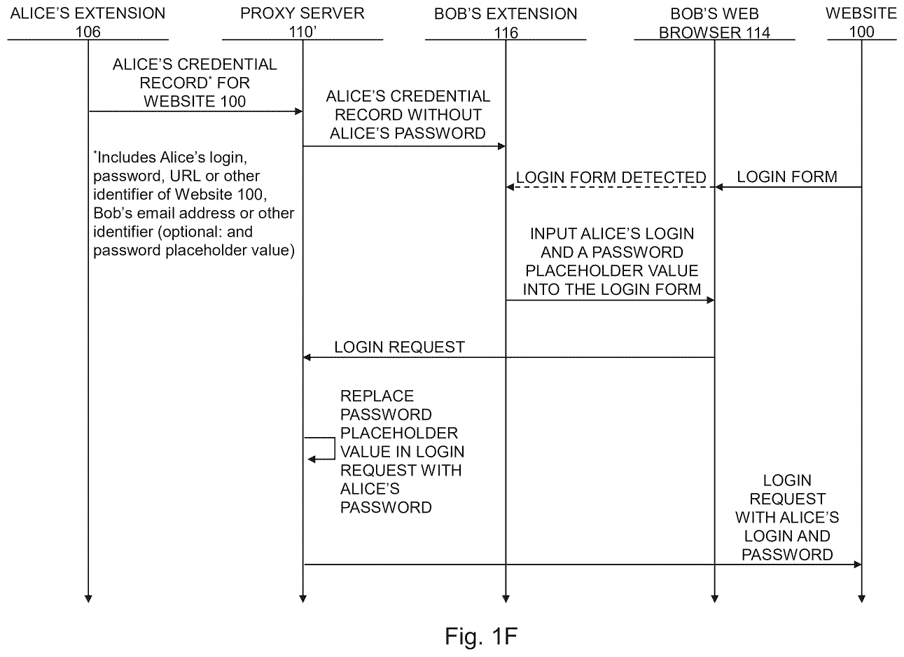

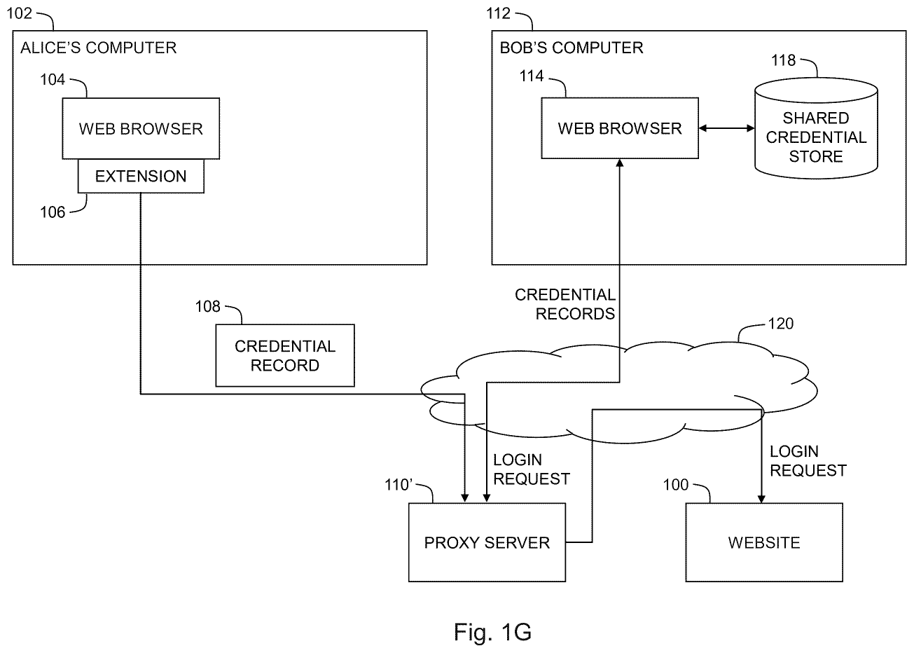

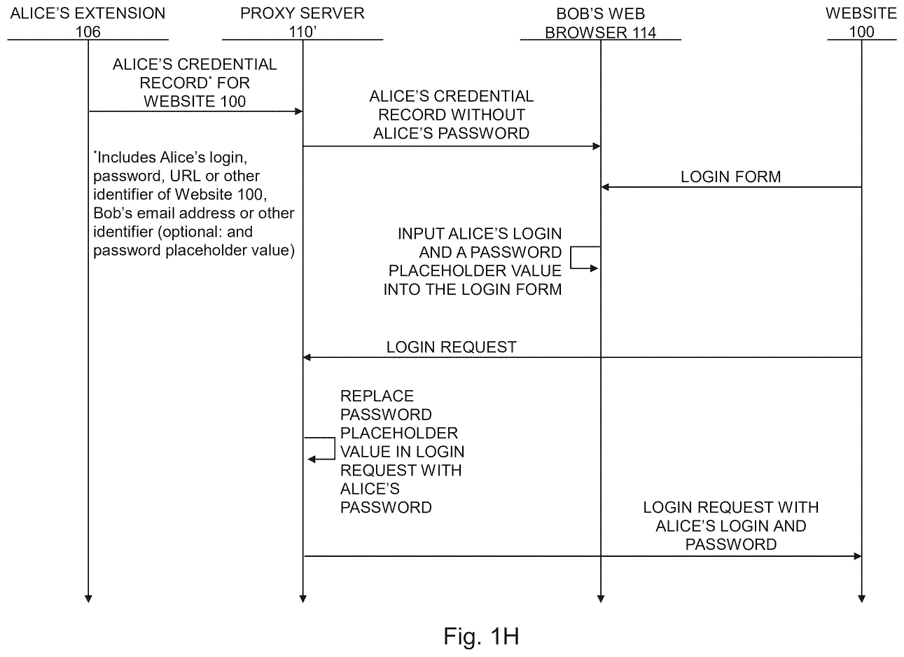

Reference is now made to FIG. 1A, which is a simplified conceptual illustration of a computer security system, constructed and operative in accordance with an embodiment of the invention, and additionally to FIG. 1B, which is a simplified action diagram of an exemplary method of operation of the system of FIG. 1A, operative in accordance with an embodiment of the invention. In the system of FIG. 1A and method of FIG. 1B, a computer user, referred to herein as ‘Alice’, wishes to share her login and password for accessing an application at a website 100 with another computer user, referred to herein as ‘Bob’, but without exposing the password to Bob. To accomplish this, Alice employs a computer 102 that is configured with a web browser 104 and a web browser extension 106. Web browser 104 is configured to incorporate the functionality of conventional web browsers, such as those based on the Google™ Chromium™ architecture. Web browser extension 106 is configured to enable Alice to provide to extension 106 a credential record 108 that is to be shared with Bob, where credential record 108 includes a Uniform Resource Locator (URL) or other network address or identifier of website 100, Alice's login and password for website 100, and Bob's email address or other identifier identifying Bob as the intended party with whom credential record 108 is to be shared. Extension 106 is further configured to provide credential record 108 to a credential server 110 via a computer network 120, such as the internet. In one embodiment, extension 106 provides credential record 108 to credential server 110 together with a placeholder password value that differs from Alice's password for website 100, such as where the placeholder password value is provided by Alice or is generated by extension 106 using any conventional technique.

Bob employs a computer 112 that is configured with a web browser 114 and a web browser extension 116. Web browser 114 is configured to incorporate the functionality of conventional web browsers, such as those based on the Google™ Chromium™ architecture, and is additionally configured to operate as is described hereinbelow. Web browser extension 116 is configured to periodically communicate with credential server 110 via the computer network for the purpose of receiving from credential server 110 any credential records, including credential record 108, that are to be shared with Bob, preferably after authenticating Bob's identity in accordance with any conventional technique, where extension 116 preferably maintains the shared credential records received from credential server 110, such as in a shared credential store 118 which extension 116 preferably maintains in computer memory only. Extension 106 is further configured to monitor websites that are accessed by web browser 114, and particularly to detect when web browser 114 accesses a login form of a website that is identified in any of the shared credential records maintained by extension 116.

When extension 116 detects when web browser 114 accesses a login form of website 100, extension 116 accesses credential record 108 that is associated with website 100, and inputs into a login field of the login form the login included in credential record 108, i.e., Alice's login. Extension 116 also inputs a password placeholder value into a password field of the login form, where the password placeholder value differs from the password included in credential record 108. In one embodiment, if credential record 108 includes a password placeholder value, the password placeholder value that extension 116 inputs into the password field of the login form is the password placeholder value included in credential record 108. In another embodiment, the password placeholder value that extension 116 inputs into the password field of the login form is generated by extension 116 in accordance with any conventional technique.

Extension 116 is further configured to detect an attempt by the user of web browser 114, i.e., Bob, to submit a login request to website 100, where the login request includes the login and the password placeholder value from the login form. Upon detecting the attempt, extension 116 replaces the password placeholder value in the login request with the password included in credential record 108, i.e. Alice's password, and instructs web browser 114 to submit the modified login request to website 100, where the submitted login request includes the login and the password included in credential record 108. In this manner, Alice's password is not input into the login form, and is therefore not viewable by Bob, but is submitted to website 100 to allow Bob to access website 100 with Alice's credentials.

Unlike a conventional web browser, web browser 114 is configured to allow extension 116 to operate as described above, such as where web browser is the Island Enterprise Browser™, commercially available from Island Technology, Inc, Dallas, Texas, U.S.A., or is configured as described in U.S. patent application Ser. Nos. 17/740,457 and 17/993,919. Thus, in one embodiment, web browser 114 employs the Google™ Chromium™ architecture and codebase and is configured to allow extension 116 to use the chrome.debugger application programming interface (API), and specifically the fetch domain API, to intercept outbound communications before they are transmitted by web browser 114 via computer networks, access POST data to find the password placeholder value included in the login request, and modify the POST data of the login request by replacing the password placeholder value in the login request with the password included in credential record 108. Web browser 114 is also preferably configured to not display the debugging banner that is normally displayed when the chrome.debugger API is used.

Reference is now made to FIG. 1C, which is a simplified conceptual illustration of a computer security system, constructed and operative in accordance with an embodiment of the invention, and additionally to FIG. 1D, which is a simplified action diagram of an exemplary method of operation of the system of FIG. 1C, operative in accordance with an embodiment of the invention. The system of FIG. 1C and method of FIG. 1D are substantially similar to the system of FIG. 1A and method of FIG. 1B, but with the notable exceptions that the system of FIG. 1C and method of FIG. 1D lacks extension 116 of FIG. 1A and FIG. 1B, and that web browser 114 is configured to perform operations described hereinabove that are performed by extension 116 of FIG. 1A and FIG. 1B.

Reference is now made to FIG. 1E, which is a simplified conceptual illustration of a computer security system, constructed and operative in accordance with an embodiment of the invention, and additionally to FIG. 1F, which is a simplified action diagram of an exemplary method of operation of the system of FIG. 1E, operative in accordance with an embodiment of the invention. The system of FIG. 1E and method of FIG. 1F are substantially similar to the system of FIG. 1A and method of FIG. 1B, but with several notable exceptions as are now described.

The system of FIG. 1E and method of FIG. 1F includes a proxy server 110′ in place of credential server 110 of FIG. 1A and FIG. 1B, and web browser 114 may be any conventional web browser. Extension 106 is configured to send credential record 108 to proxy server 110′, and extension 116 is configured to receive from proxy server 110 any credential records, including credential record 108, that are to be shared with Bob, but where the credential records are provided by proxy server 110′ to extension 116 without their passwords. When extension 116 detects when web browser 114 accesses a login form of website 100, extension 116 accesses credential record 108 that is associated with website 100, inputs into a login field of the login form the login included in credential record 108, i.e., Alice's login, and inputs a password placeholder value into a password field of the login form, where the password placeholder value differs from the password included in credential record 108.

Extension 116 is further configured to thereafter route communications with website 100 through proxy server 110′, such as by using the chrome.proxy API. Thus, extension 116 is configured to detect an attempt by the user of web browser 114, i.e., Bob, to submit a login request to website 100, where the login request includes the login and the password placeholder value from the login form. Upon detecting the attempt, extension 116 routes the login request to proxy server 110′. Proxy server 110′ then replaces the password placeholder value in the login request with the password included in credential record 108, i.e. Alice's password, and submits the login request to website 100, where the submitted login request includes the login and the password included in credential record 108. In this manner, Alice's password is never sent to Bob, but is submitted by proxy server 110′ to website 100 to allow Bob to access website 100 with Alice's credentials.

Reference is now made to FIG. 1G, which is a simplified conceptual illustration of a computer security system, constructed and operative in accordance with an embodiment of the invention, and additionally to FIG. 1H, which is a simplified action diagram of an exemplary method of operation of the system of FIG. 1G, operative in accordance with an embodiment of the invention. The system of FIG. 1G and method of FIG. 1H are substantially similar to the system of FIG. 1A and method of FIG. 1B, but with several notable exceptions as are now described.

The system of FIG. 1G and method of FIG. 1H lacks extension 116 of FIG. 1A and FIG. 1B and includes a proxy server 110′ in place of credential server 110 of FIG. 1A and FIG. 1B. Web browser 114 is configured to receive from proxy server 110′ any credential records, including credential record 108, that are to be shared with Bob, but where the credential records are provided by proxy server 110′ to web browser 114 without their passwords.

When web browser 114 accesses a login form of website 100, web browser 114 accesses credential record 108 that is associated with website 100, inputs into a login field of the login form the login included in credential record 108, i.e., Alice's login, and inputs a password placeholder value into a password field of the login form, where the password placeholder value differs from the password included in credential record 108. Web browser 114 is further configured to thereafter route communications with website 100 through proxy server 110′. Thus, when the user of web browser 114, i.e., Bob, attempts to submit a login request to website 100, where the login request includes the login and the password placeholder value from the login form, web browser 114 routes the login request to proxy server 110′. Proxy server 110′ then replaces the password placeholder value in the login request with the password included in credential record 108, i.e. Alice's password, and submits the login request to website 100, where the submitted login request includes the login and the password included in credential record 108. In this manner, Alice's password is never sent to Bob, but is submitted by proxy server 110′ to website 100 to allow Bob to access website 100 with Alice's credentials.

Any aspect of the invention described herein may be implemented in computer hardware and/or computer software embodied in a non-transitory, computer-readable medium in accordance with conventional techniques, the computer hardware including one or more computer processors, computer memories, I/O devices, and network interfaces that interoperate in accordance with conventional techniques.

It is to be appreciated that the term “processor” or “device” as used herein is intended to include any processing device, such as, for example, one that includes a CPU (central processing unit) and/or other processing circuitry. It is also to be understood that the term “processor” or “device” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart illustrations and block diagrams in the drawing figures illustrate the architecture, functionality, and operation of possible implementations of systems, methods, and computer program products according to various embodiments of the invention. In this regard, each block in the flowchart illustrations or block diagrams may represent a module, segment, or portion of computer instructions, which comprises one or more executable computer instructions for implementing the specified logical function(s). In some alternative implementations, the functions noted in a block may occur out of the order noted in the drawing figures. For example, two blocks shown in succession may, in fact, be executed substantially concurrently, or the blocks may sometimes be executed in the reverse order, depending upon the functionality involved. It will also be noted that each block of the flowchart illustrations and block diagrams, and combinations of such blocks, can be implemented by special-purpose hardware-based and/or software-based systems that perform the specified functions or acts.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A computer security method comprising:
detecting when a web browser accesses a login form of a website;
accessing a credential record associated with the website, wherein the credential record includes a login and a password;
inputting the login into a login field of the login form;
inputting a password placeholder value into a password field of the login form, wherein the password placeholder value differs from the password included in the credential record;
detecting an attempt by a user of the web browser to submit a login request to the website, wherein the login request includes the login and the password placeholder value from the login form;
replacing the password placeholder value in the login request with the password included in the credential record; and
submitting the login request to the website, wherein the submitted login request includes the login and the password included in the credential record.

2. The computer security method according to claim 1 wherein the detecting, accessing, inputting, replacing, and submitting are performed by the web browser.

3. The computer security method according to claim 1 wherein the detecting, accessing, inputting, replacing, and submitting are performed by an extension of the web browser.

4. The computer security method according to claim 1 and further comprising retrieving the password placeholder value from the credential record.

5. The computer security method according to claim 1 wherein the login identifies a person other than the user of the web browser.

6. The computer security method according to claim 1 wherein the detecting, accessing, inputting, replacing, and submitting are implemented in any of
a) computer hardware, and
b) computer software embodied in a non-transitory, computer-readable medium.

7. A computer security method comprising:
receiving from a web browser a login request that is addressed to a website, wherein the login request includes a login and a password placeholder value;
accessing a credential record associated with the login and the website, wherein the credential record includes the login and a password;
replacing the password placeholder value in the login request with the password included in the credential record; and
submitting the login request to the website, wherein the submitted login request includes the login and the password included in the credential record.

8. The computer security method according to claim 7 and further comprising providing the credential record to a user of the web browser, prior to receiving the login request, in accordance with an identification indicating that the credential record is to be shared with the user of the web browser, wherein the login identifies a person other than the user of the web browser.

9. The computer security method according to claim 1 wherein the receiving, accessing, replacing, and submitting are performed by a proxy server.

10. The computer security method according to claim 9 and further comprising proxying communications between the website and the web browser.

11. The computer security method according to claim 7 wherein the receiving, accessing, replacing, and submitting are implemented in any of
a) computer hardware, and
b) computer software embodied in a non-transitory, computer-readable medium.
